(19) United States
(12) Patent Application Publication
(10) Pub. No.: US 2005/0166060 A1
(43) Pub. Date: Jul. 28, 2005

(54) System and method for controlling access to resources

(76) Inventors: Flora Goldthwait, Seattle, WA (US); Jonathan C. Cluts, Sammamish, WA (US); Pamela J. Heath, Seattle, WA (US)

Correspondence Address: SHOOK, HARDY & BACON L.L.P., 2555 GRAND BOULEVARD, KANSAS CITY, MO, 64108-2613, US

(21) Appl. No.: 10/763,226

(22) Filed: Jan. 26, 2004

(51) Int. Cl. H04K 1/00

(52) U.S. Cl. 713/182

(57) ABSTRACT

A method and system are provided for controlling child access to a set of resources in a computerized environment. The system may include a credit storage area for storing credits, wherein each credit entitles the child to a fixed amount of access to the set of resources. The system may additionally include credit tracking tools for adding and subtracting credits from the credit storage area in response to monitored activities of the child and an access regulation module. The access regulation module denies child access to the set of resources upon detection of insufficient credits in the credit storage area. A method for controlling a child's access includes tracking credits earned in response to a child's performance of selected activities and tracking credits used in response to the child's use of the set of resources. The method additionally includes denying child access to the set of resources if insufficient credits exist in the credit storage area.

### FIELD OF THE INVENTION

The present invention relates to the field of controlling access to resources in a computerized enviroment. More specifically, the present invention is directed to a customized approach for controlling access to resources.

### BACKGROUND OF THE INVENTION

With the vast quantity of information available over the Internet, parents have become more concerned in recent years with controlling child access to this information. Parents have become concerned not only with the content of information that children are able to access, but also with the amount of time that children spend absorbing this information. As a result, various controls have been developed.

Some controls that have been developed to restrict child access such that children are only able to access specific web sites or are unable to access web sites with specified content. Other controls deny access altogether or at certain times of day. Such devices generally include filtering software stored implemented by a parent on a home computer or by a school administrator on a school computer. These techniques have limited scope. For instance, parents often would like to restrict children from entertainment until homework or chores are completed. The techniques that have been developed do not allow for this type of customized instruction.

Additionally, with widespread adoption of wireless networks and the proliferation of networked devices and objects, it is desirable to create products that intelligently take advantage of these networking capabilities. One currently available networking option is Bluetooth, which is a short-range radio technology aimed at simplifying communications among Internet devices and between Internet devices and other computers. Bluetooth uses short-range radio links to replace cables between computers and connected units.

Using Bluetooth and other similar technologies, mobile devices can communicate with one another when the devices are within a pre-determined distance from one another. For instance, a Bluetooth computer can detect a Bluetooth printer in its vicinity and wirelessly execute a print job. Similarly, a mobile phone using the Bluetooth network can communicate with a nearby computer to inform a user that the computer has received an email.

Other technologies that facilitate communications between devices include wireless local area networks (WLANs), wireless application protocol (WAP), and Infrared Technologies such as IrDA-Data. All of these technologies are capable of simplifying wireless communications between devices and can be used optimally in different environments. For example, WLANs are LAN protocols modulated on carrier waves. WLANs can handle greater data throughput than Bluetooth and are generally server-based, whereas Bluetooth technologies are generally peer-to-peer. WAP is a communications protocol for mobile phones intended to extend available Internet-based services. Infrared (IR) technologies require that a data beam be aimed at a receiving antenna. Accordingly, IR technologies require a free line of sight.

With these currently available technologies that facilitate wireless communications as well as with more traditional networks, it is desirable to extend administrator control over a child's activities to become operable over a network of participating devices. Accordingly, a solution is needed that will allow parents and other adults to exert customized control over a child's activities in a networked computerized environment. A solution is also needed that allows for restricting child access based on the tasks completed by the child and for restricting child access based on time constraints imposed for selected activities.

### SUMMARY OF THE INVENTION

Although the invention is described primarily in conjunction a parent/child example, the invention may also be applied to other types of administrators who are required to control access of others to resources.

In one aspect, the present invention is directed to a system for controlling child access to a set of resources in a computerized environment. The system includes a credit storage area for storing credits, wherein each credit entitles the child to a fixed amount of access to the set of resources. The system may additionally include credit tracking tools for adding and subtracting credits from the credit storage area in response to monitored activities of the child and an access regulation module for denying child access to the set of resources upon detection of insufficient credits in the credit storage area.

In an additional aspect, the present invention is directed to a method for controlling a child's access to a set of resources in a computerized environment. The method includes storing a set of credits in a credit storage area, wherein each credit entitles the child to a fixed amount of access to the set of resources, tracking credits earned in response to a child's performance of selected activities, and tracking credits used in response to the child's use of the set of resources. The method may additionally include denying child access to the set of resources if insufficient credits exist in the credit storage area.

### BRIEF DESCRIPTION OF THE DRAWINGS

The present invention is described in detail below with reference to the attached drawing figures, wherein:

FIG. 1 is a block diagram of an embodiment of a system of the invention;

FIG. 2 is a block diagram showing a suitable computing environment for implementing the system of the invention;

FIG. 3 is a block diagram illustrating a software platform for use in an embodiment of the invention;

FIG. 4 is a flow chart illustrating a method in accordance with an embodiment of the invention;

FIG. 5 illustrates a parental control screen display in accordance with an embodiment of the invention;

FIG. 6 illustrates a main screen display in accordance with an embodiment of the invention;

FIG. 7 illustrates a game screen display in accordance with an embodiment of the invention;

FIG. 8 illustrates an additional screen display of the game in accordance with an embodiment of the invention;

FIG. 9 illustrates a further screen display of the game in accordance with an embodiment of the invention;

FIG. 10 illustrates a further screen display of the game in accordance with an embodiment of the invention;

FIG. 11 illustrates a further screen display of the game in accordance with an embodiment of the invention;

FIG. 12 illustrates a child screen display in accordance with an embodiment of the invention;

FIG. 13 illustrates a further child screen display in accordance with an embodiment of the invention; and

FIG. 14 illustrates an additional child screen display from a school server in accordance with an embodiment of the invention.

### DETAILED DESCRIPTION OF THE INVENTION

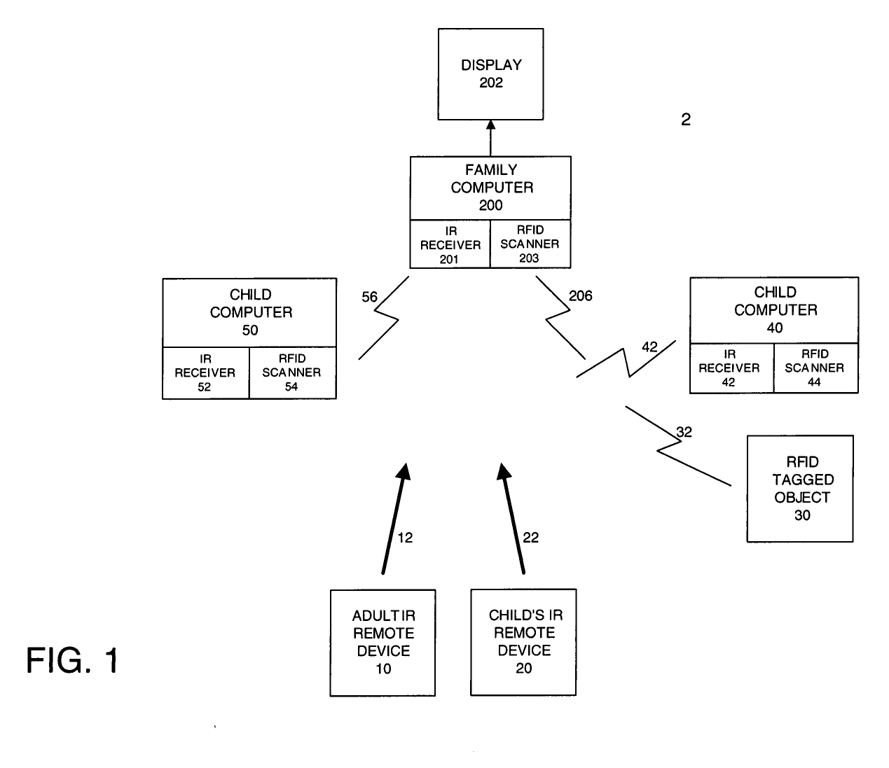

FIG. 1 illustrates an embodiment of the system of the invention. A system 2 may include a plurality of participants such as an adult IR remote device 10, a child IR remote device 20, radio frequency identification (RFID) tagged objects 30, child computers 40 and 50, and a family computer 200 connected with a display 202. The child computers 40 and 50 and the family computer 200 may also be connected with infrared receivers 42, 52, and 201 respectively and RFID tag scanners 44, 54, and 203, respectively. The participants in the system 2 may be connected over a network and may communicate with one another using a variety of techniques. Although child computers 40 and 50 are illustrated, the child devices may also include a telephone, a television, or other devices.

In an embodiment of the invention, the family computer 200 may act as a server. Accordingly, a parent may set rules as will be further described below from the family computer 200 for the child computers 40 and 50. The child remote 20 and the adult remote 20 may have different rights with respect to the system as set forth in rules stored in the family computer 200.

As an example of how the child may interact with the above-described environment, the child may have a portable touch screen with a user interface including an educational display selected by a parent from the family computer 200. While the child may have access to the same areas of content as the rest of the family, her experience may be tailored to reflect her rights within the family. Although a child may have some choices as to desktop content, certain tasks may appear until the obligation for them has been met. Accordingly, a child may have customization capabilities within specific parameters and after obligations have been met. As will be further described below, her touch screen may include a display having a quick link to homework created by the parent. Games or television watching may not be permitted until pre-set homework requirements are met.

As a further example, remote control devices may be complicated. Accordingly, a child's remote control device, such as the remote control device 20 may have simplified buttons and may respond to display a UI that matches the remote control. Furthermore, a remote control device used by an adult may produce one experience on the television and a child remote control device may create another television experience.

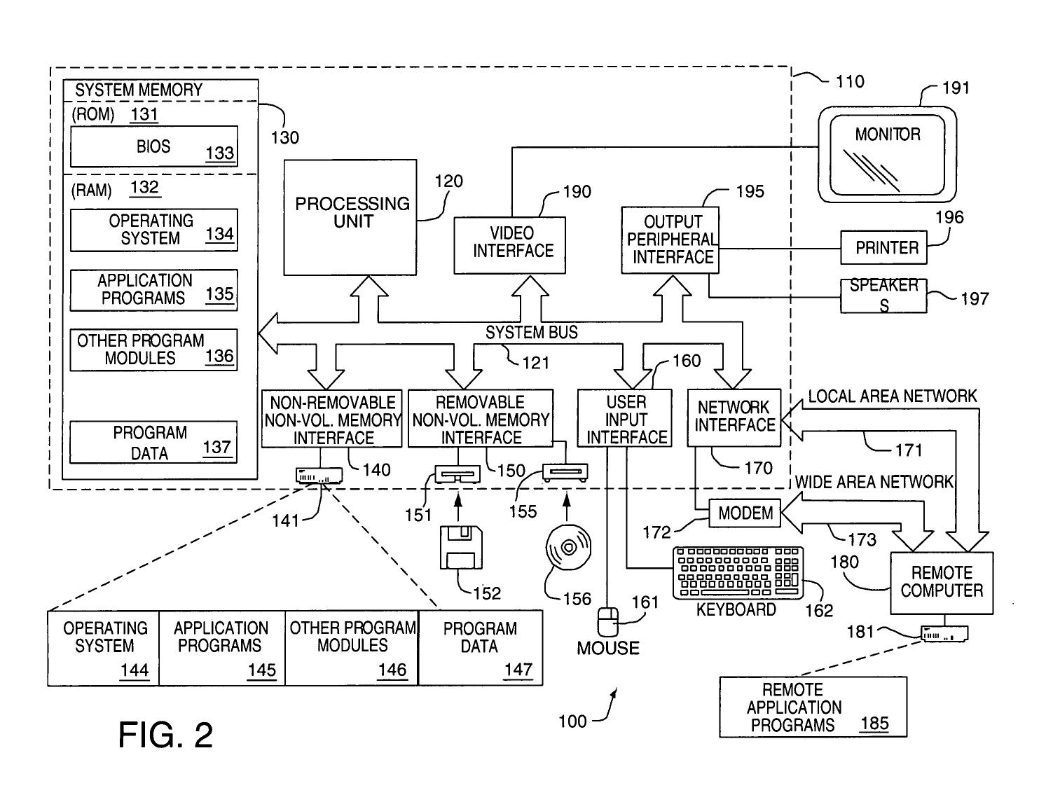

FIG. 2 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a USB. A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention may operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

In embodiments of the invention, the remote computer 180 could be a server for a school website that accepts assignments from remote users. The remote computer 180 could also include a server pertaining to extracurricular projects.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

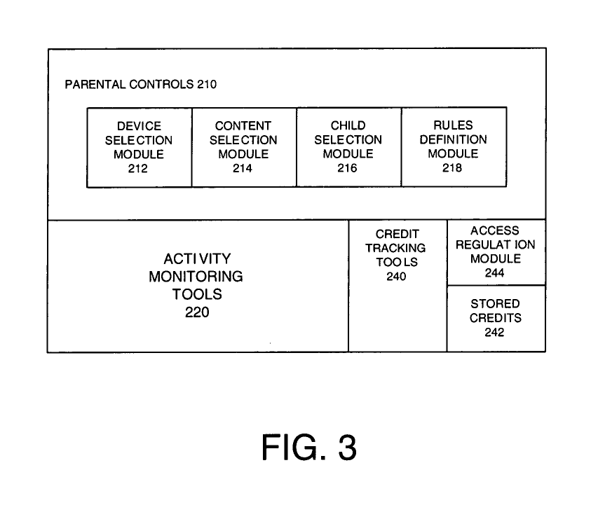

FIG. 3 is a block diagram illustrating an exemplary software platform in accordance with an embodiment of the invention. The software preferably includes a set of parental controls 210 available to the parent through a user interface on a computer such as the family computer 200. The parental controls 210 preferably include a device selection module 212, a content selection module 214, a child selection module 216, and a rules definition module 218. The software platform may also include activity monitoring tools 220, credit tracking tools 240, a credit storage area 242, and an access regulation module 244. Although the term “parent” is used, any administrator including a parent, guardian, babysitter, or teacher may operate the aforementioned controls.

The device selection module 212 preferably allows a parent to select a device to control. The device may be a selected child computer or other device. The content selection module 214 may allow a parent to select a particular set of content for each participating device or for each participating child. The child selection module 216 may include a list of children, since parents may want to set different rules for different children. The rules definition module 218 allows a parent, administrator, or other adult to set specific rules. For instance, rules may require an hour of homework from each child before playtime. Playtime may include game playing, talking on the telephone, watching television, or other pre-defined fun activities. Rules may include restrictive time-frames during which children are not permitted to play games. Many different types of rules may be set for each child and each device.

The activity monitoring tools 220 monitor a child's activities to determine when a child is playing games and when the child is doing homework or housework. The activity monitoring tools may include a software module but may further include other types of tools that may be used to monitor activity such as a camera connection to a computer. Alternatively, activity monitoring tools could require a parent to monitor activity and enter the observed activities into the system.

The credit tracking tools 240 assign credits to activities performed by a child in accordance with the rules set in the rules definition module 218. A child will earn credits for performing homework tasks and doing work around the house such as room cleaning or for other required tasks, such as writing a letter to grandmother. A child may use credits by watching television, playing computer games, or participating in other enjoyable activities. The credit tracking tools 240 add the credits accumulated and store them in the credit storage area 242. When a child participates in fun activities, the credit tracking tools 240 deduct credits from the credit storage area 242. When the child participates in work activities, the credit tracking tools 240 add credits to the credit storage area 242. The access regulation module 244 keeps track of the number of credits in the storage area 242 and detects when the child does not have enough credits to perform a requested activity.

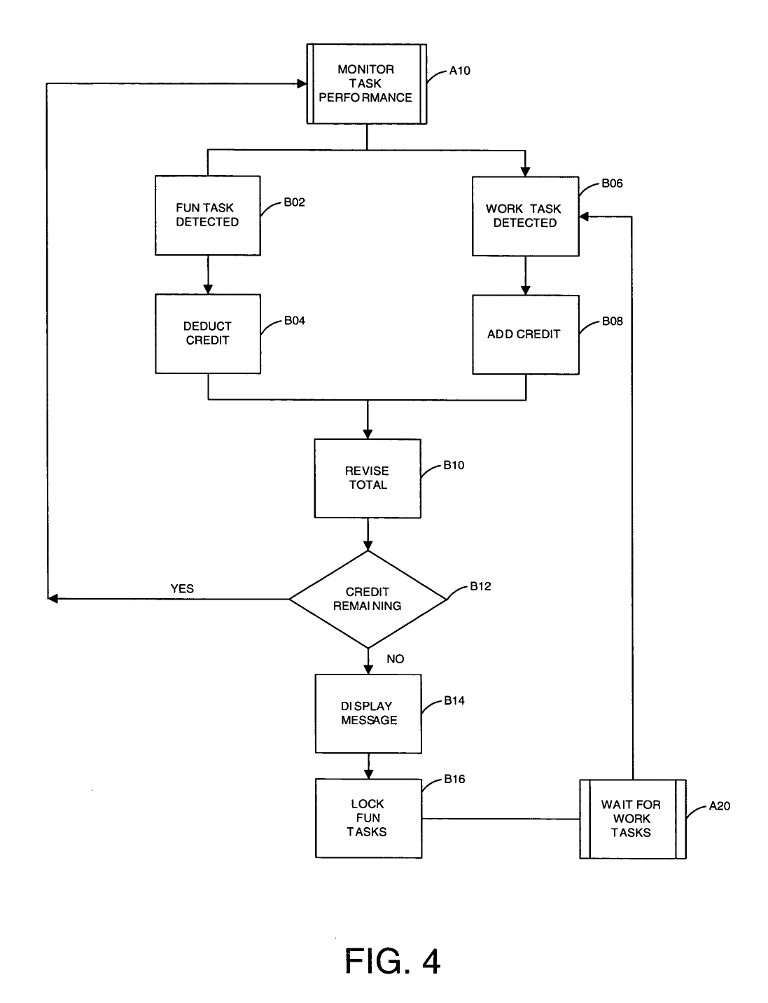

FIG. 4 is a flowchart illustrating a method in accordance with an embodiment of the invention. In Procedure A10, the system monitors task performance. As set forth above with respect to the activity monitoring tools 220, activity monitoring can be performed using a number of different techniques. Depending on whether a fun task is detected in step B02 or a work task is detected in step B06, the credit tracking tools 240 either deduct credit in step B04 or add credit in step B08. In step B10, the credit tracking tools 240 revise the total number credits stored in the credit storage area 244.

In step B12, the access regulation module 244 determines if credits remain. If credits remain, the system continues monitoring. Whether “credits remain” could be determined by assessing whether a credit threshold has been crossed. Furthermore, the access regulation module 244 could determine both a threshold at which the number of credits has become low and furthermore could monitor when the credits have been completely depleted. These types of choices may be made by the adult or system administrator. If no credits are remaining, the access regulation module 244 may display a message in step B14 warning a child user that the number of credits available is low or that no credits are available. Other messages, such as prompts to perform work tasks, may also be displayed.

In step B16, the system locks fun tasks and in procedure A20, the system monitors for work tasks. If a work task is detected in step B06, the credit is added and the process continues.

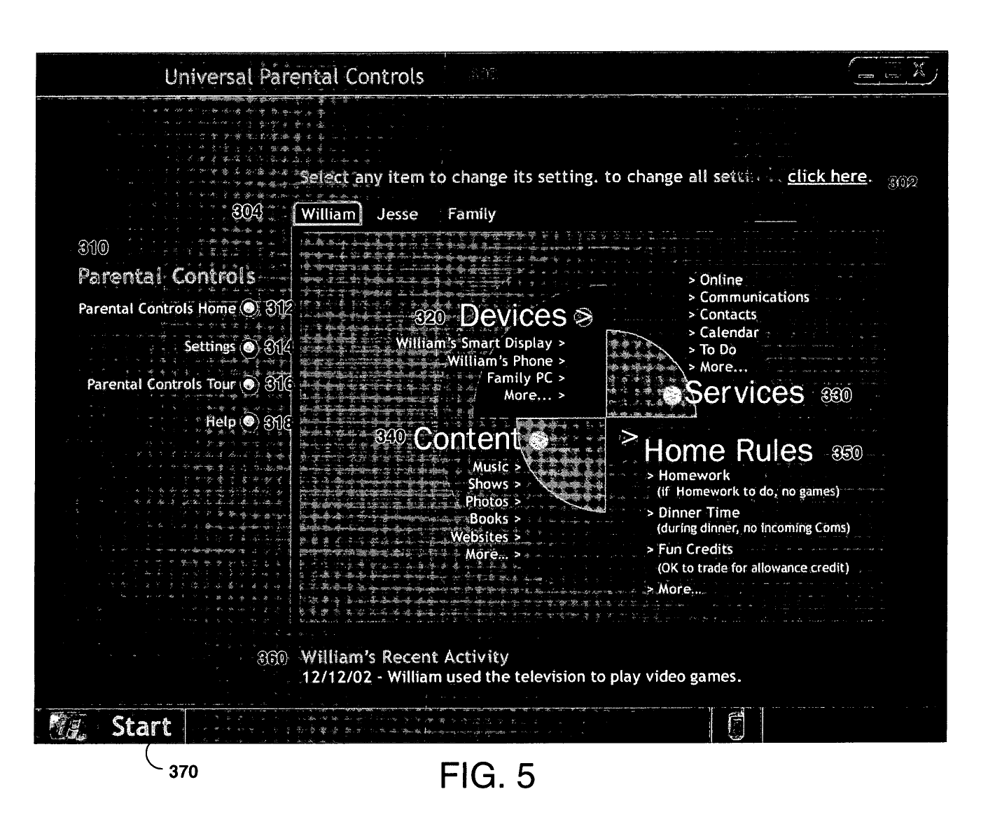

FIG. 5 is a screen display illustrating universal parental controls 300. An adult user may change all settings in section 302. The children and family are listed in section 304. Clicking on any member of the family will change the focus to that member. Parental controls 310 include a home section 312, settings 314, tour 316, and help 318. A device selection area 320 allows the parent to select a device to control such as a “smart display”, a telephone, a family PC, or any other device connected to the network. Section 330 provides a list of services to choose from. The list of services may include for example online services, communication services, contacts, a calendar, a “to do” list and more. A content section may allow an adult to regulate specific content available to the users. Content may include such items as music, shows, photographs, books, websites, and other types of content. A rules section 350 allows an adult to select or enter rules. As shown, rules may be related to homework. For instance, the rules could forbid games until homework is done. The rules may optionally be related to restricting activities during dinnertime. For example, phone calls, or incoming communications could be forbidden during dinner time. The rules section may also include rules for fun credits, for instance authorizing trading of fun credits for allowance credit. Section 360 provides the adult with an accounting of a selected child's recent activity. A start button 370 is available for choosing alternate programs and settings.

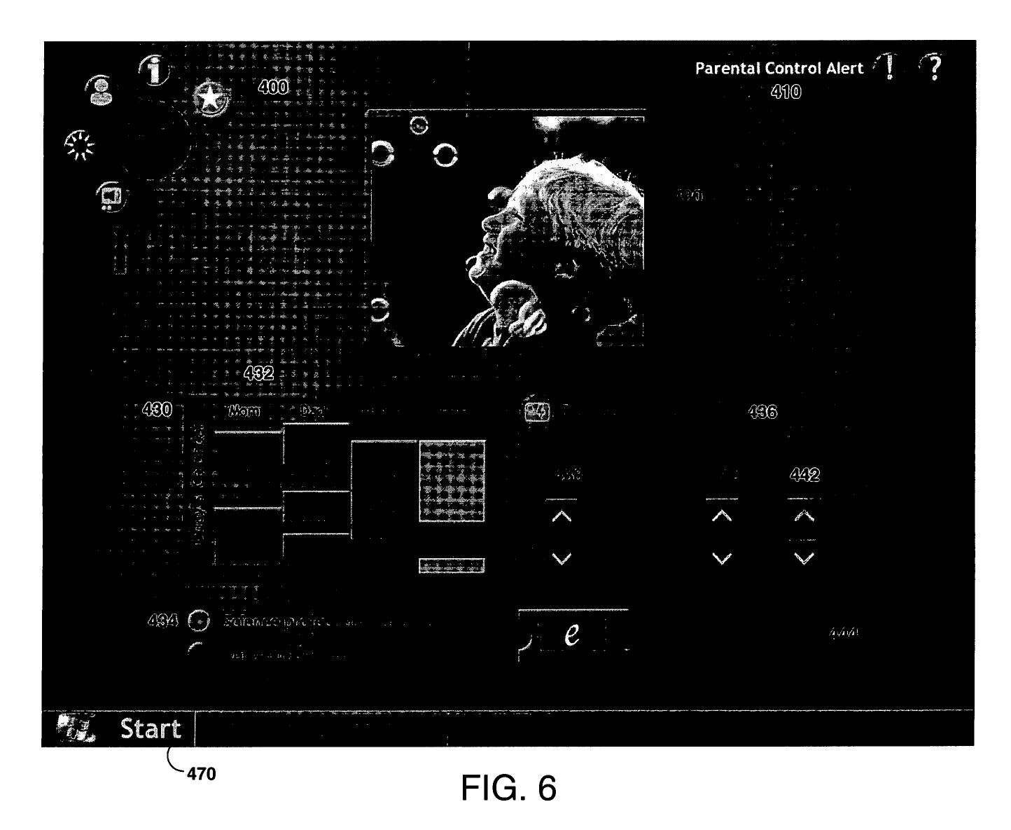

FIG. 6 illustrates an exemplary main screen for a family computer such as the computer 200 of FIG. 1. A section 400 may include various selectable information icons. A parental control alert 410 may be provided. The parental control alert 410 could be used to keep a parent informed regarding a child's activities or a child's attempts to partake in specified activities. A photo section 420 may be provided. A family calendar 430 may include a listing of the names 432 of all family members. Upcoming due dates 434 may include appointments or projects due. Section 436 reminds the user that the oven is on. Section 438 displays the current temperature and may give a user the opportunity to adjust the current temperature. Section 440 provides an adjustment mechanism for blinds and section 442 provides an adjustment mechanism for lights. Tickets 444 are also selectable on the main screen.

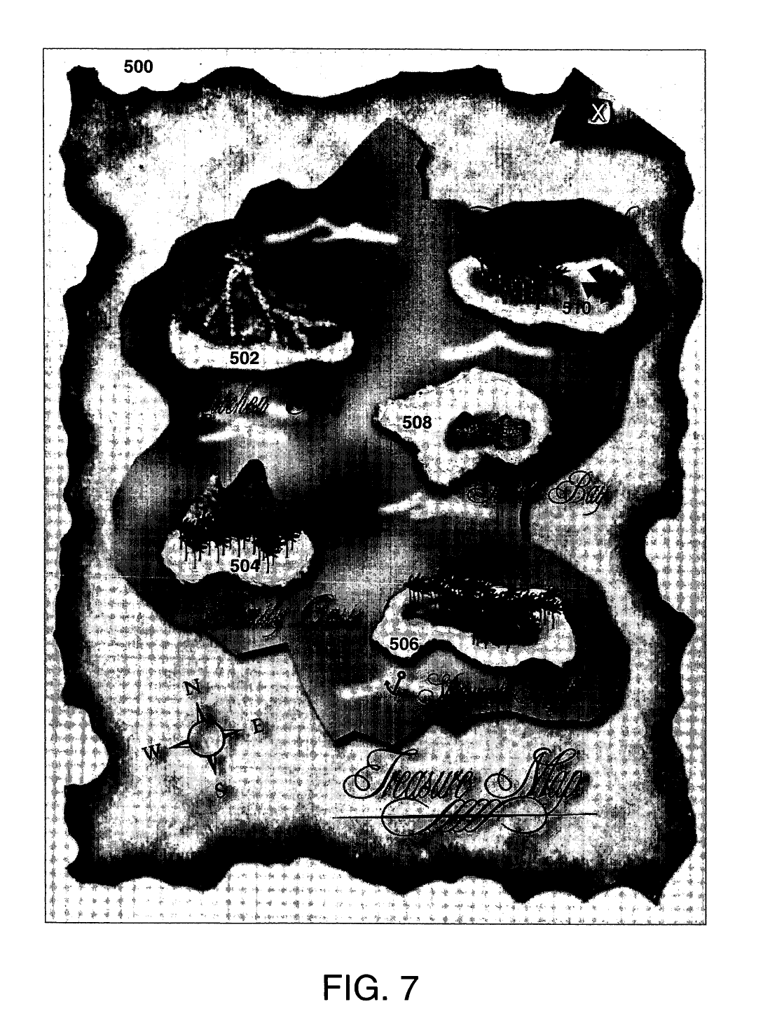

FIG. 7 shows an embodiment of a child user interface 500 in which the child is playing a treasure hunting game. The interface 500 is a treasure map, which provides a representation of the home and icons for visually tracking activity within the home. The icons represent areas such as a kitchen cove 502, a family oasis 504, a shipwreck reef 506, Jesse's bay 508, and treasure island 510.

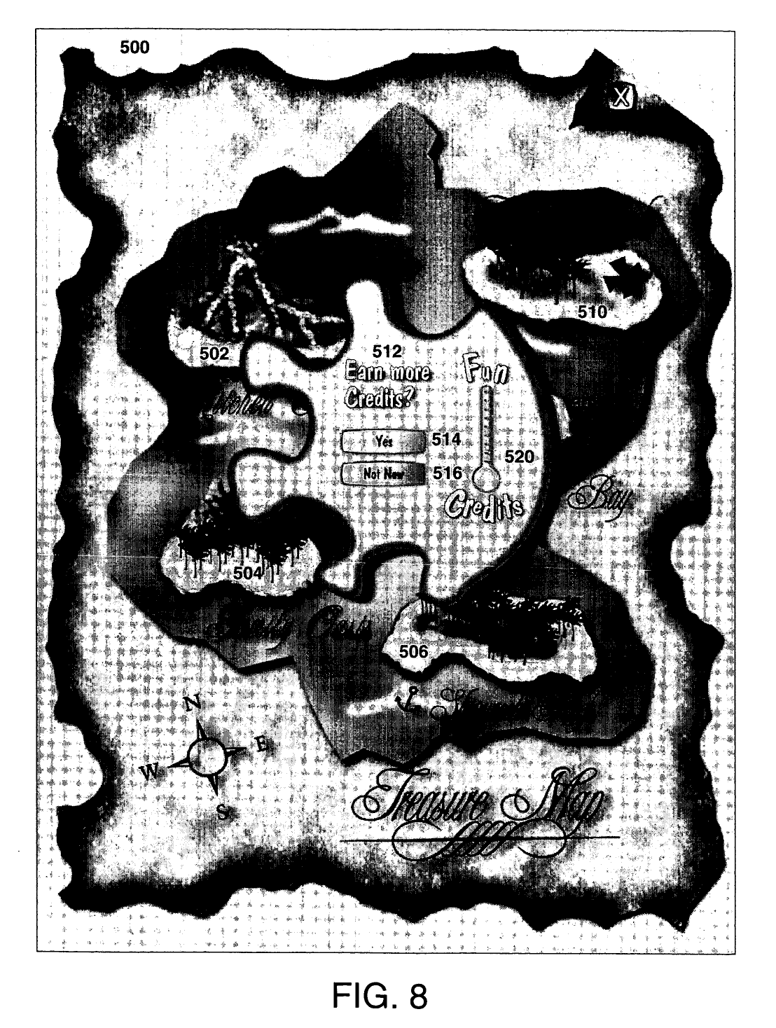

FIG. 8 illustrates the child user interface including a prompt 512 asking the child if he or she would like to earn more fun credits. The child can select “yes” 514 or “not now” 516. A fun credit gauge 520 provides a child with an indication of how many fun credits are available.

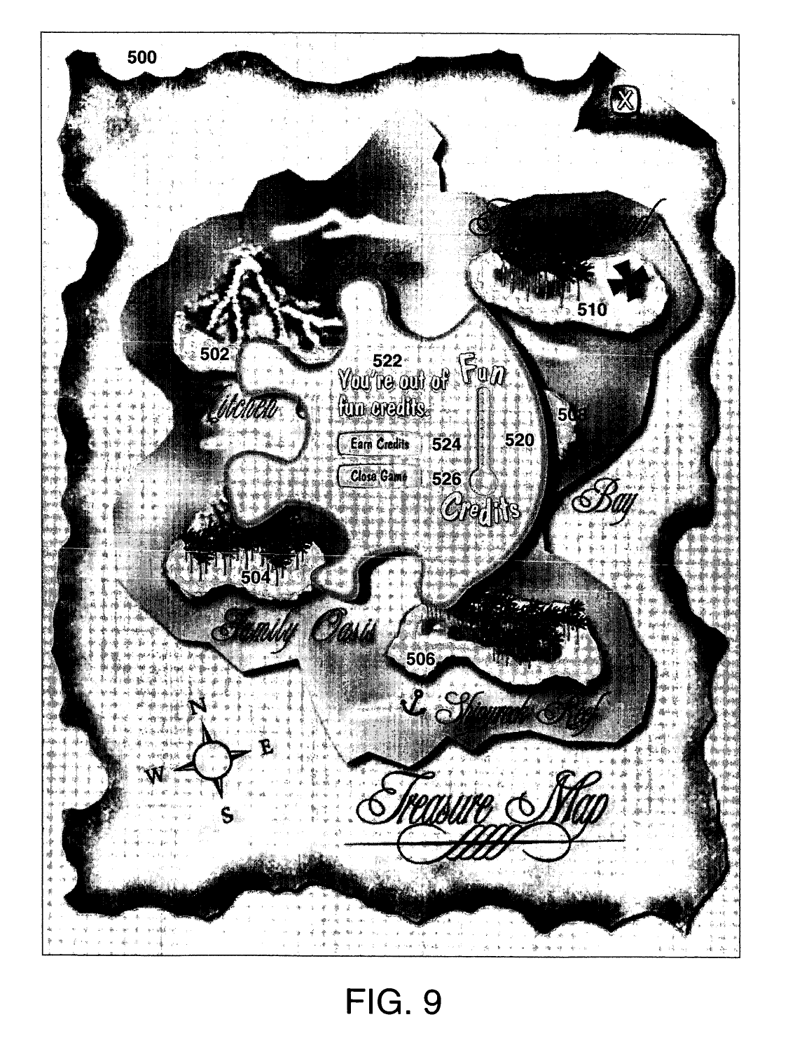

FIG. 9 illustrates the child user interface 500 when the child has exhausted available fun credits. A message 522 indicates that the child is out of fun credits. The child can select “earn credits” 524 or “close game “526”. The fun credits gauge 520 shows no more fun credits remaining.

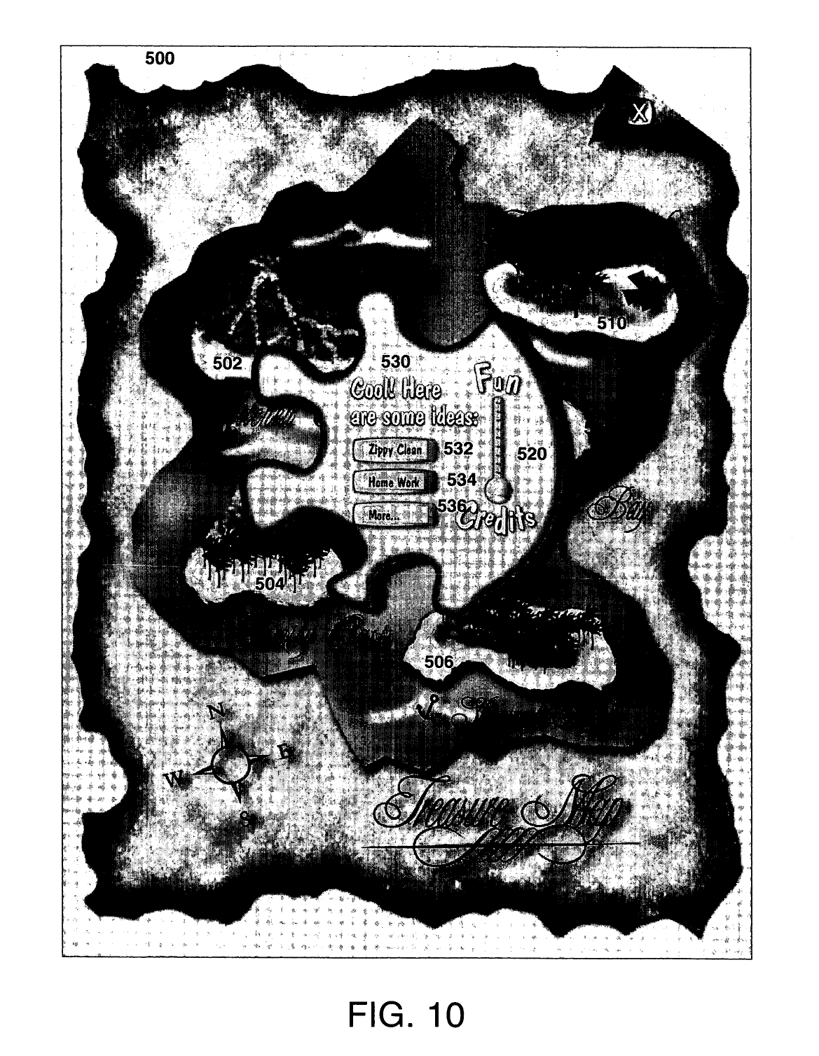

FIG. 10 illustrates the child user interface 500 if the child chooses to earn more fun credits. A message 530 tells the child that multiple ideas for earning fun credits are available. The child may select “zippy clean” 532, which may be a room cleaning task, “homework” 534, or other options 536.

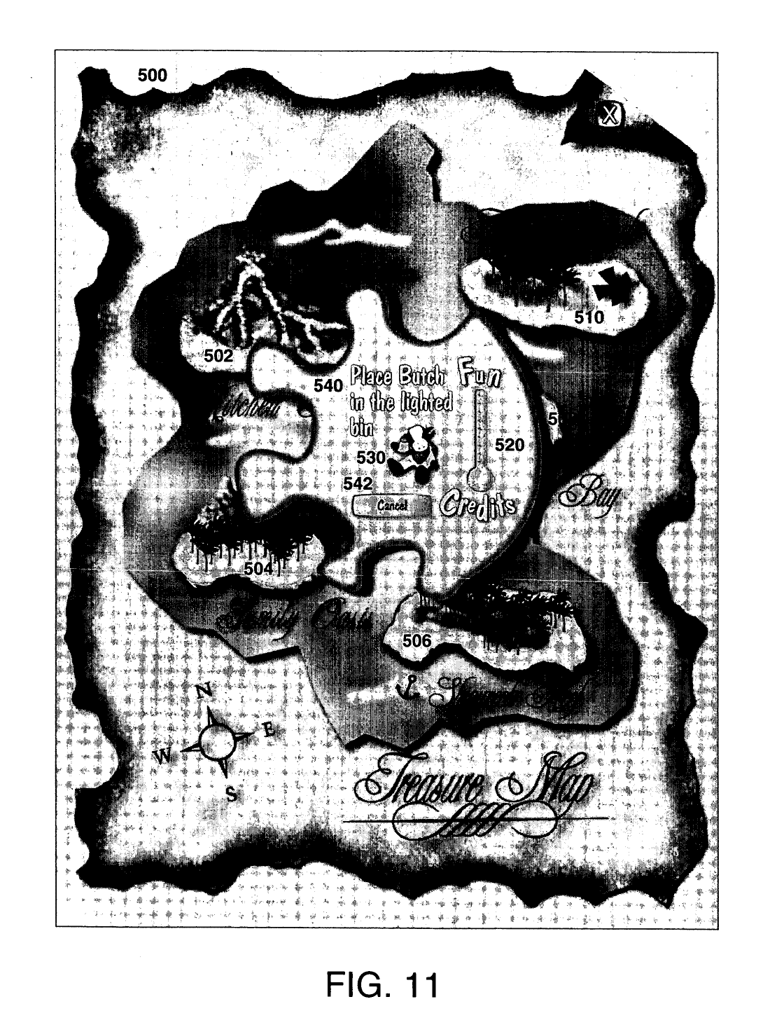

FIG. 11 illustrates the child user interface if the child selects the room-cleaning task. The user interface 500 provides an instruction 540 to place an object 530 in a lighted bin. In this embodiment, the object 530 may be an RFID tagged object such that the computer can implement activity monitoring tools 220 to monitor through RF identification, whether the object 530 has been placed in the bin. A cancellation option 542 allows the child to cancel the task. If the task is performed, the fun credits gauge 520 will register newly earned fun credits.

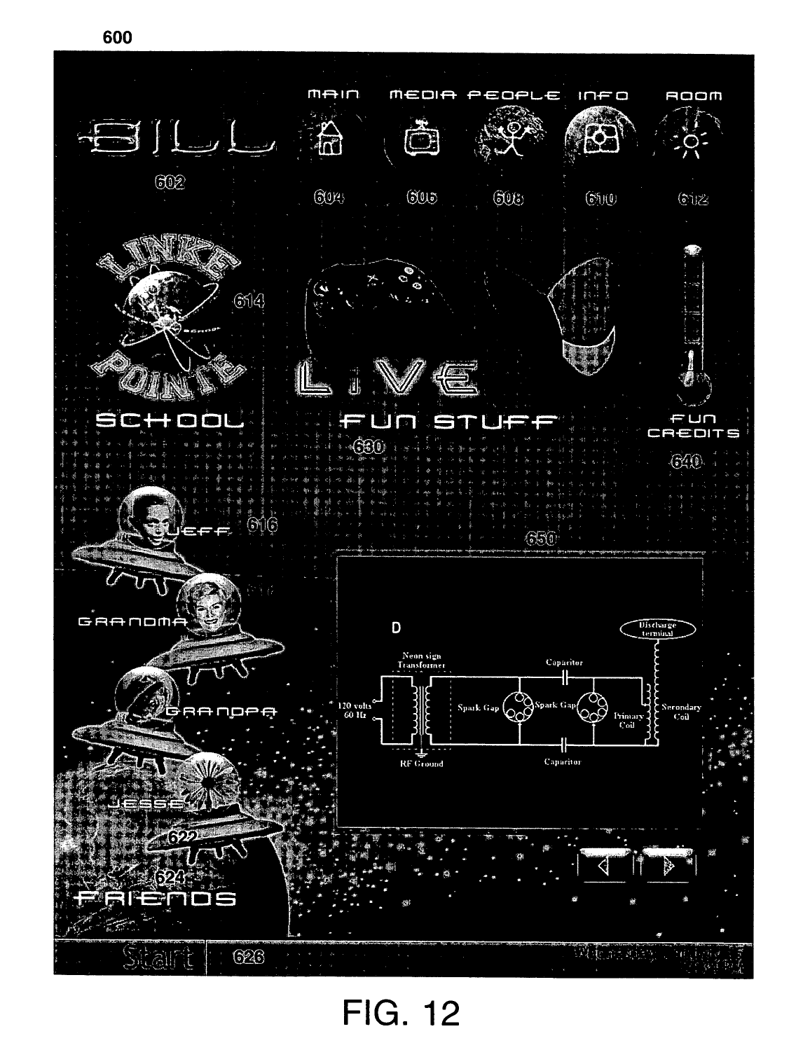

FIG. 12 illustrates another child user interface 600. This child user interface 600 includes the child's name 602 and links to different locations such as “main” 604, media 606, people 608, info 610, and room 612. An additional link 614 may provide access to a school server. Family members 616, 618, 620, and 622 may each have a separate icon. Friends 624 may have a separate icon. A fun icon 630 may provide a child with access to games and other enjoyable resources. An information window 650 may provide the child with requested information. A fun credits gauge 640 is again provided to measure availability of fun tasks.

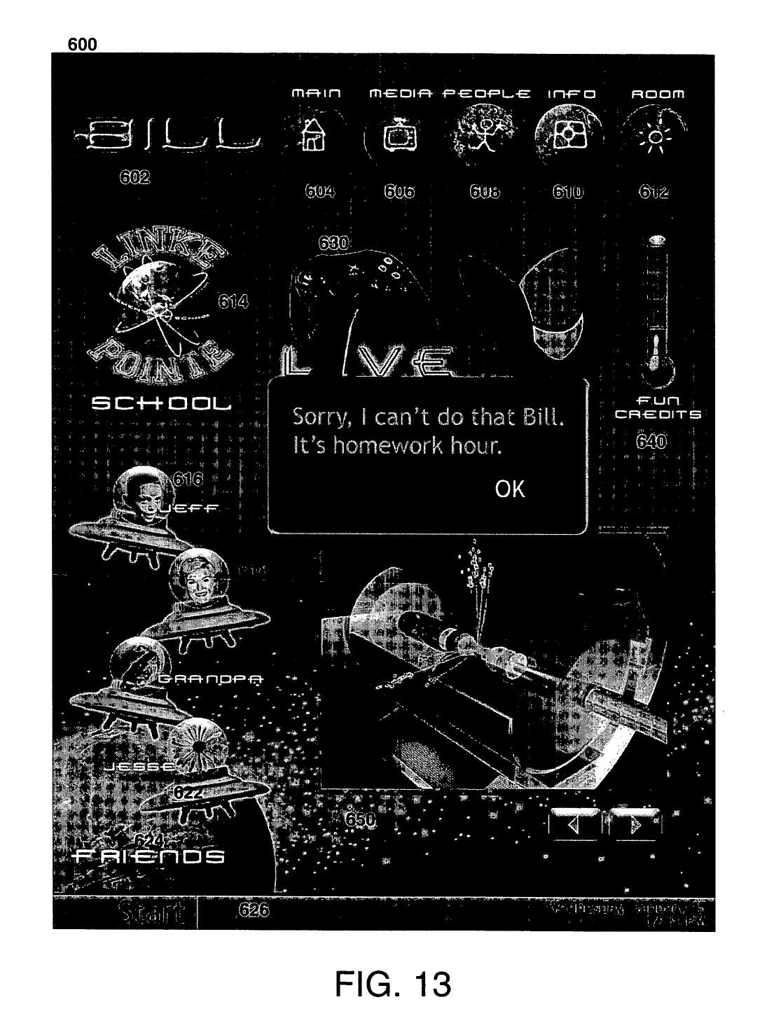

FIG. 13 illustrates the user interface 600 when the child attempts to access the fun icon 630. A display 602 advises the child in accordance with defined rules from the rules definition module 218 (shown in FIG. 3) that games cannot be played during homework hour.

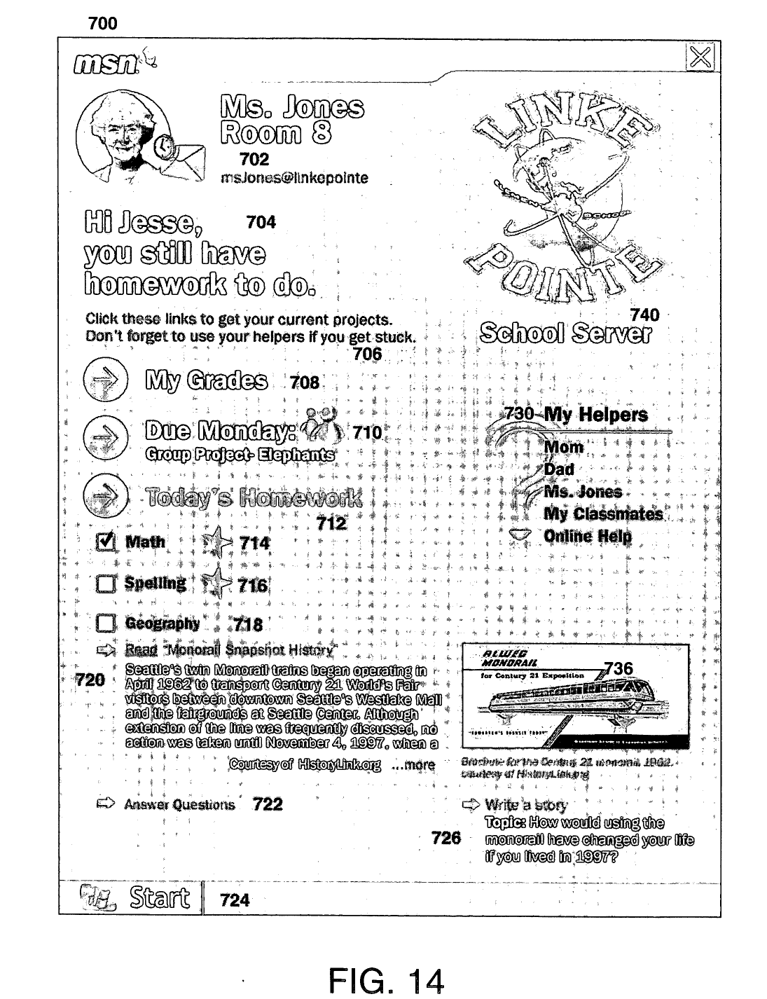

FIG. 14 illustrates a user interface 700 in which a child has accessed a school server. The teacher is shown and identified in section 702. In section 704, the school server indicates whether the child has remaining tasks. Section 706 allows a child to access current projects. The child can access his or her grades through the icon 708 and can access a group project through icon 710. Today's homework is accessible in section 712 and is categorized into math 714, spelling 716, and geography 718. A reading assignment is accessible in section 720 and a writing assignment is accessible in section 726. The child may also access helpers 730. The school server is identified in section 740.

The present invention has been described in relation to particular embodiments, which are intended in all respects toe illustrative rather than restrictive. Alternative embodiments will become apparent to those skilled in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and with the scope of the claims.

1. A system for controlling child access to a set of resources in a computerized environment, the system comprising:
a credit storage area for storing credits, wherein each credit entitles the child to a fixed amount of access to the set of resources;
credit tracking tools for adding and subtracting credits from the credit storage area in response to monitored activities of the child; and
an access regulation module for denying child access to the set of resources upon detection of insufficient credits in the credit storage area.

2. The system of claim 1, further comprising administrator controls including a rules definition module for allowing an administrator to set access rules.

3. The system of claim 2, wherein the administrator controls further comprise a child selection module enabling the administrator to create a rule set for each child.

4. The system of claim 2, wherein the administrator controls further comprise a device selection module for allowing the administrator to apply the access rules to a selected device.

5. The system of claim 2, wherein the administrator controls further comprise a content selection module enabling the administrator to select content viewable by the child.

6. The system of claim 1, further comprising activity monitoring tools for determining if a child performs a required activity.

7. The system of claim 1, further comprising a child user interface including a credit gauge enabling the child to view available credits.

8. The system of claim 7, wherein the child interface includes a prompting display for prompting the child to earn credits.

9. The system of claim 7, wherein the child user interface includes a notification display for notifying a child that insufficient credits are available.

10. The system of claim 7, wherein the child user interface further comprises a prompting display for prompting the child to perform required tasks.

11. The system of claim 1, further comprising an administrator user interface including a child activity log for allowing the parent to view the most recently performed child activity.

12. A method for controlling a child's access to a set of resources in a computerized environment, the method comprising:
storing a set of credits in a credit storage area, wherein each credit entitles the child to a fixed amount of access to the set of resources;
tracking credits earned in response to a child's performance of selected activities;
tracking credits used in response to the child's use of the set of resources; and
denying child access to the set of resources if insufficient credits exist in the credit storage area.

13. The method of claim 12, further comprising allowing an administrator to select a child from a list of children using a child selection module.

14. The method of claim 12, further comprising allowing an administrator to set access rules using a rules definition module.

15. The method of claim 12, further comprising providing a child selection module enabling an administrator to create a rule set for each child.

16. The method of claim 12, further comprising providing a device selection module for allowing an administrator to apply the access rules to a selected device.

17. The method of claim 12, further comprising providing a content selection module enabling an administrator to select content viewable by the child.

18. The method of claim 12, further comprising monitoring child activities in order to keep track of earned credits.

19. The method of claim 12, further comprising providing a child user interface including a credit gauge enabling the child to view available credits.

20. The method of claim 19, further comprising prompting the child to earn credits with the child user interface.

21. The method of claim 19, further comprising notifying the child with the child user interface when insufficient credits are available.

22. The method of claim 19, further comprising prompting the child on the child user interface to perform required tasks.

23. The method of claim 12, further comprising providing an administrator user interface with a child activity log for allowing the administrator to view recently performed child activities.
